(19) United States
(12) Patent Application Publication
(10) Pub. No.: US 2022/0260802 A1
(43) Pub. Date: Aug. 18, 2022

(54) LAYBOX FOR MICROTENCHING AND METHOD OF MICROTRENCHING USING THE LAYBOX

(71) Applicant: CCIIP LLC, New York, NY (US)

(72) Inventor: Angelo J. Pino, JR., New York, NY (US)

(21) Appl. No.: 17/411,180

(22) Filed: Aug. 25, 2021

Related U.S. Application Data
(60) Provisional application No. 63/070,539, filed on Aug. 26, 2020.

(51) Int. Cl. G02B 6/50; E02F 5/10

(52) U.S. Cl. CPC G02B 6/504; E02F 5/10

(57) ABSTRACT

A laybox having a body formed from opposing first and second elongated sheets of steel defining an elongated chamber between them, the body having a thickness of 1 to 6 inches to fit within a microtrench, and a front end of the body configured to face a microtrencher cutting blade and a back end of the body opposing the first end; and a cable guide disposed in the elongated chamber configured to guide an optical fiber cable and/or microduct/innerduct through the chamber. A method of cutting a microtrench and installing optical fiber cable and/or innerduct/microduct in the microtrench.

### FIELD OF THE INVENTION

The invention generally relates to a laybox for use in microtrenching and a method of microtrenching using the laybox to install optical fiber cable and/or microduct/innerduct in a microtrench.

### BACKGROUND OF THE INVENTION

Installing optical fiber in a microtrench often has problems with the microtrench side walls caving in when the microtrench is formed in soft dirt, sand or gravel below the hard roadway (asphalt or cement), along a side the hard roadway or in a soft roadway such as a dirt or gravel roadway.

### SUMMARY OF THE INVENTION

An objective of the invention is to provide a solution to the problem of sidewalls of a microtrench caving in.

The objectives of the invention and other objectives are obtained by a laybox configured for installing optical fiber cable in a microtrench comprising:
a body comprising opposing first and second elongated sheets of steel defining an elongated chamber between them, the body having a thickness of 1 to 6 inches to fit within a microtrench, and a front end of the body configured to face a microtrencher cutting blade and a back end of the body opposing the first end; and
a cable guide disposed in the elongated chamber configured to guide an optical fiber cable and/or microduct/innerduct through the chamber.

The objectives of the invention and other objectives are also obtained by a method of microtrenching comprising:
cutting a microtrench in a roadway with a microtrencher and depositing spoil from the microtrench on one side of the microtrench;
moving a laybox in the microtrench behind the microtrencher in a direction the microtrencher is travelling, the laybox comprising opposing first and second elongated sheets of steel defining an elongated chamber between them and a cable guide in the elongated chamber;
flowing an optical fiber cable and/or innerduct/microduct through the chamber and cable guide so that the optical fiber cable and/or innerduct/microduct is laying in the microtrench;
pushing the spoil into the microtrench using a spoil diverter; and
compressing the spoil in the microtrench using a compression wheel.

The objectives of the invention and other objectives can also be obtained by a method of microtrenching comprising:
cutting a microtrench in a roadway comprising asphalt or cement with a microtrencher;
vacuuming spoil from the microtrench using a vacuum device;
moving a laybox in the microtrench behind the microtrencher in a direction the microtrencher is travelling, the laybox comprising opposing first and second elongated sheets of steel defining an elongated chamber between them and a cable guide in the elongated chamber;
flowing an optical fiber cable and/or innerduct/microduct through the chamber and cable guide so that the optical fiber cable and/or innerduct/microduct is laying in the microtrench; and
flowing a fill from a fill device to a fill conduit in the laybox so that the fill flows through the fill conduit and into the microtrench to seal the microtrench and protect the optical fiber cable and/or innerduct/microduct.

### BRIEF DESCRIPTION OF THE DRAWINGS

FIG. 1 illustrates a view of a first embodiment of the laybox connected to a microtrencher.

FIG. 2 illustrates a side view of the laybox.

FIG. 3 illustrates a top view of the laybox.

FIG. 4 illustrates a view of a second embodiment of the laybox connected to a microtrencher, a vacuum device and a fill device.

FIG. 5 illustrates a side view of the second embodiment of the laybox.

FIG. 6 illustrates a top view of the second embodiment of the laybox.

### DETAILED DESCRIPTION OF THE INVENTION

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention with reference to the attached non-limiting figures.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description.

During installation of the optical fiber cable, a microtrencher is used to cut a microtrench in the roadway, optical fiber cable and/or innerduct/microduct is then laid in the microtrench, and then the microtrench is filled with a fill and sealant over the optical fiber cable and/or innerduct/microduct to protect them from the environment. The present method utilizes a motorized vehicle, a microtrencher, and a laybox to install the optical fiber cable within the microtrench.

Microtrenchers, other devices used in microtrenching, fills, and methods of microtrenching that can be utilized in the present invention include the devices and methods described in my previous U.S. patent publication Nos. 20190226603, 20190086002, 20180292027, 20180156357, and 20180106015, the complete disclosures of which are incorporated in their entirety herein by reference.

Any suitable microtrencher 2 can be utilized in the present invention. Non-limiting examples of suitable microtrenchers 2 include those made and sold by Ditch Witch, Vermeer, and Marais. A Vermeer RTX 1250 tractor can be used as the motorized vehicle for the microtrencher 2. A microtrencher 2 is a “small rock wheel” specially designed for work in rural or urban areas. The microtrencher 2 is fitted with a cutting wheel 10 that cuts a microtrench 11 with smaller dimensions than can be achieved with conventional trench digging equipment. Microtrench 11 widths usually range from about 6 mm to 130 mm (¼ to 5 inches) with a depth of 750 mm (about 30 inches) or less. Other widths and depths can be used as desired.

With a microtrencher 2, the structure of the road, sidewalk, driveway, or path is maintained and there is no associated damage to the road. Owing to the reduced microtrench 11 size, the volume of waste material (spoil 12) excavated is also reduced. Microtrenchers 2 are used to minimize traffic or pedestrian disturbance during cable laying. A microtrencher 2 can work on sidewalks or in narrow streets of cities, and can cut harder ground than a chain trencher, including cutting through for example but not limited to hard surfaces solid stone, concrete, and asphalt. Softer surfaces include, soil, grass, dirt, sand, and gravel.

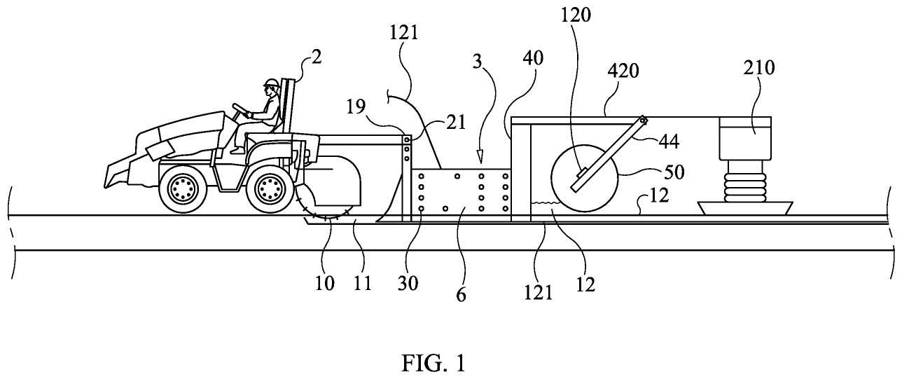

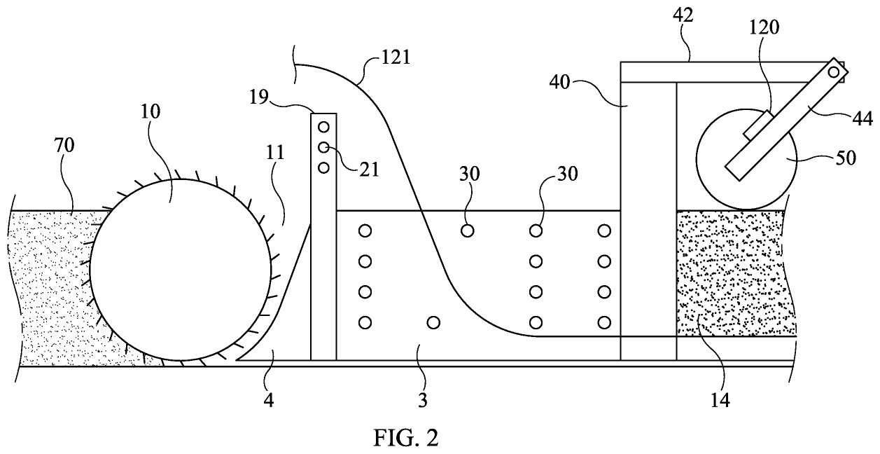

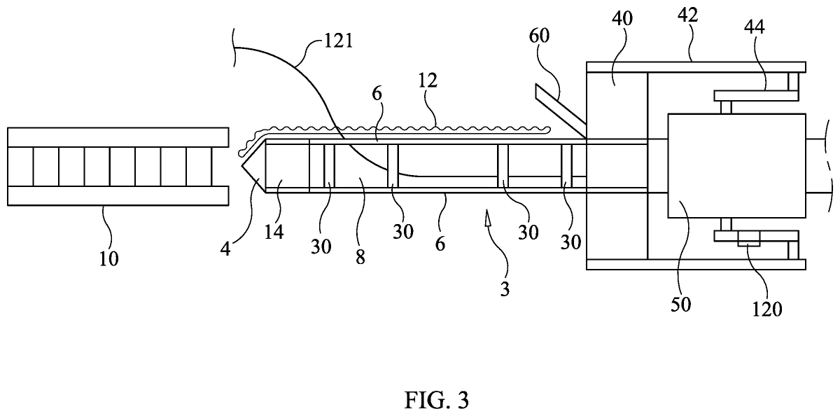

In a first embodiment, an example of which is shown in FIGS. 1-3, a side-discharge cutting wheel 10 is utilized, which deposits spoil 12 to one side of the microtrench, as shown in FIG. 2. The first embodiment is usually used for softer surfaces, such as dirt roads, gravel roads, and the soft sides of a hard (asphalt or cement) roadway. The term “side-discharge cutting wheel 10” includes any microtrench cutting wheel configured to deposit the spoil 12 to a side of the cut microtrench 11, examples of which are conical and diamond cutting wheels.

The laybox 3 can be formed by two opposing side walls 6 defining a elongated chamber 8 therebetween. The chamber 8 defined by the side walls 6 should be sized so that the optical fiber cable and/or innerduct/microduct 121 can flow into and through the chamber 8 during use. Examples of suitable chamber 8 widths are from 0.5 to 10 inches, more preferably from 1 to 4 inches in width between the interior surfaces of the opposing side walls 6. The side walls 6 are preferably formed from sheets of steel. Examples of suitable thickness of a side wall 6 formed from a steel sheet is 0.1 to 1.5 inches, preferably 0.1 to 1 inches. The length of the of the wall 6 can be as desired for the particular application. In general, the longer the length of the wall 6, the greater the radius of any turns with the laybox 3 inside the microtrench 11. When turning, the laybox 3 may have to be removed from the microtrench 3. Exemplary lengths of the wall 6 is from 6 inches to 5 feet, preferably from 1 to 2 feet. The height of the laybox 3 can vary as desired for the particular application, such as higher for a deeper microtrench 11 and lower for a shallower microtrench 11. An example of suitable heights of the side walls 6 are from 6 inches to 3 feet, preferably from 6 inches to 2 feet.

The side wads 6 can be connected to each other by one or more spacers 30. The spacers 30 can also have the function of guiding the optical fiber cable and/or innerduct/microduct 121 into and through the laybox 3 and then to bottom of the microtrench 11. For example, the spacers 30 can be bolts that bolt the sides walls 6 together.

A crummer 4 can be located at the front of the laybox 3. The crummer 4 is configured to remove remaining spoil 12 or other objects from the microtrench 12. The crummer 4 can have a pointed or angled surface to facilitate removal of the spoil 12.

A microtrencher connector 19 can be located near the front of the laybox 3 for connecting the laybox 3 to the microtrencher 2. The microtrencher connector 19 can have holes 21 for bolting the microtrencher connector 19 to the microtrencher 2.

A spoil diverter 60 can be located near the back of the laybox 3, which is configured to push the spoil 12 deposited on the roadway surface into the microtrench 11 after the optical fiber cable and/or innerduct/microduct 121 has been laid in the bottom of the microtrench 11.

A compression wheel 50 can be mounted at the back of the laybox 3 for compressing the spoil 12 in the microtrench 11. The compression wheel 50 can be mounted to compression wheel mount 40 and mount support arm 42 by a swing arm 44, which allows the compression wheel 50 to move up and down. To adjust the amount of compression applied by the compression wheel 50, weight 120 can be added to swing arm 44. The compression wheel 50 can be formed from steel, or any other suitable material.

In addition to the compression wheel 50 or replacing the compression wheel 50, a compactor 210 can be included as shown in FIG. 1. The compactor 210 can be a vibrating tamper or compactor. Commercial examples of suitable compactor 210 include the plate compactors made by Bartell, Yuutool, Powerhouse, Nordco, Honda, Waymag, Yardmax, Rammer, and others.

During use in the first embodiment, the microtrench 11 can be cut in the soft roadway using the blade 10 to deposit spoil 12 on one side of the microtrench 11. The laybox 3 connected to the microtrencher 2 is dragged forward inside the microtrench 11 as the microtrencher 2 moves forward. The crummer 4 pushes any spoil 12 or other debris in the microtrench 11 up and out of the way of the laybox 3. As the laybox 3 moves forward in the microtrench 11, the optical fiber cable and/or innerduct/microduct 121 is fed through the chamber 8, the path being controlled by the spacers 30, until the optical fiber cable and/or innerduct microduct 121 lays at the bottom of the microduct. The spoil diverter 30 pushes the spoil 12 on the roadway surface into the microtrench 11 on top of the optical fiber cable and/or innerduct/microduct 121. The compression wheel 50 rotates over the spoil 12 and compresses the spoil 12 into the microtrench 11 over the buried optical fiber cable and/or innerduct/microduct 121.

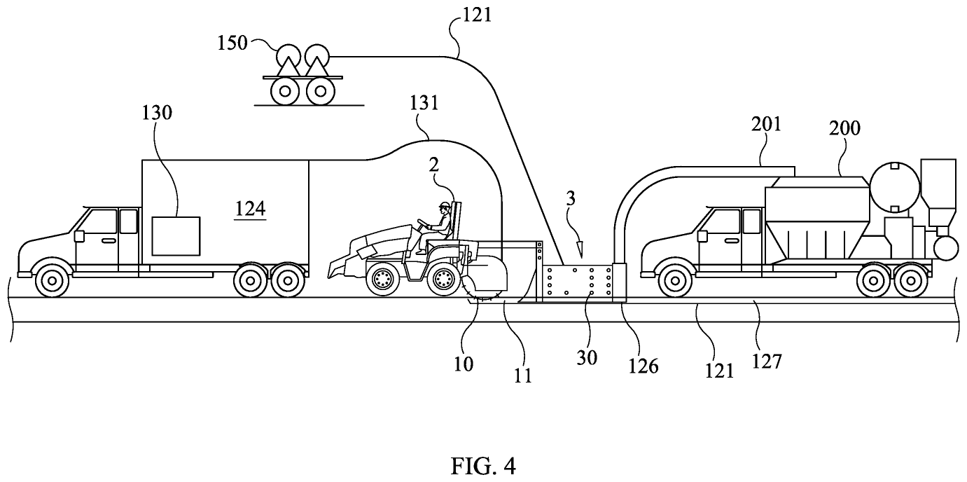

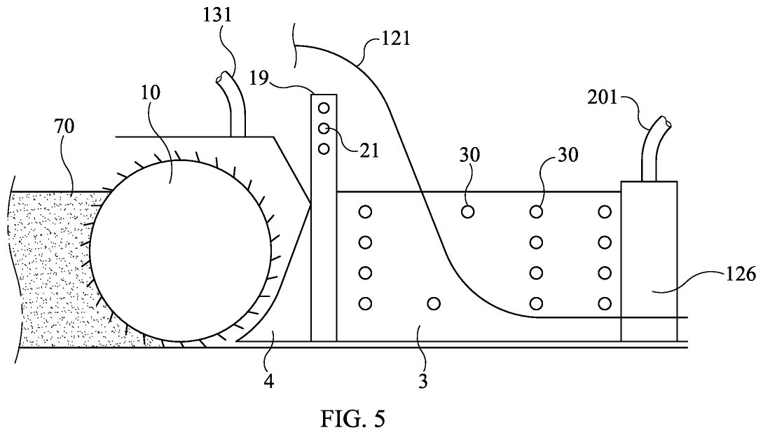

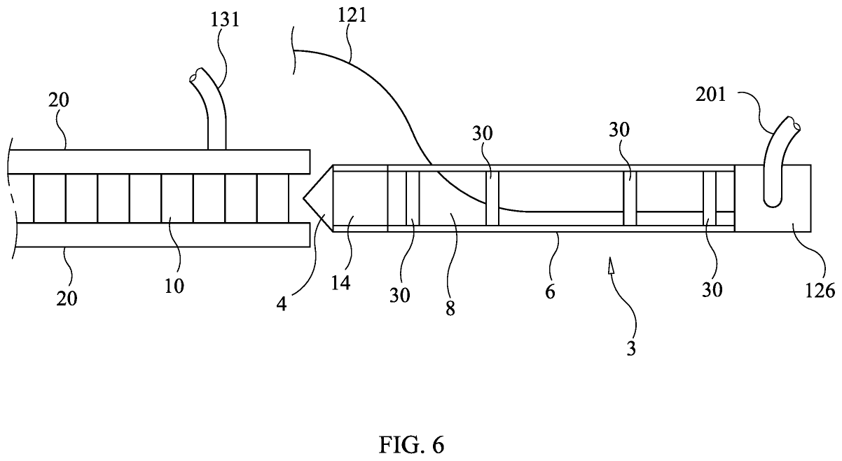

In the second embodiment, as shown in FIGS. 4-6, the spoil 12 is vacuumed by a vacuum device 130, which can be mounted on a vacuum truck 124. The vacuum device 130 can be any desired device, such as those made by SCAG Giant Vac., DR Power, Vermeer, and Billy Goat. A preferred vacuum truck 124 is a Guzzler vacuum truck, www.guzzler.com. The Guzzler type vacuum truck 124 has a large storage container for holding spoil 12 and a vacuum device 130 for creating a vacuum in the storage container. The storage container can be sized to hold spoil 12 created by the side-discharge cutting wheel 10 cutting a microtrench 11 in the roadway. The microtrencher 2 can also include the vacuum systems disclosed in my copending U.S. patent application Ser. No. 16/806,335, filed 2 Mar. 2020, the complete disclosure of which is incorporated herein by reference. The vacuum device 130 can be connected to a microtrencher shroud 20 by a vacuum hose 131, or to a separate shroud as disclosed in my copending application. In this manner, the spoil 12 can be easily removed from the roadway and microtrench 11.

In the second embodiment, the laybox 3 should be sized to fit within a microtrench 11 cut into the roadway. The laybox 3 can be formed by two opposing side walls 6 defining an elongated chamber 8 therebetween. The chamber 8 defined by the side walls 6 should be sized so that the optical fiber cable and/or innerduct/microduct 121 can flow into and through the chamber 8 during use. Examples of suitable chamber 8 widths are from 0.5 to 10 inches, more preferably from 1 to 4 inches in width between the interior surfaces of the opposing side walls 6. The side walls 6 are preferably formed from sheets of steel. Examples of suitable thickness of a side wall 6 formed from a steel sheet is 0.1 to 1.5 inches, preferably 0.1 to 1 inches. The length of the of the wall 6 can be as desired for the particular application. In general, the longer the length of the wall 6, the greater the radius of any turns with the laybox 3 inside the microtrench 11. When turning, the laybox 3 may have to be removed from the microtrench 3. Exemplary lengths of the wall 6 is from 6 inches to 5 feet, preferably from 1 to 2 feet. The height of the laybox 3 can vary as desired for the particular application, such as higher for a deeper microtrench 11 and lower for a shallower microtrench 11. An example of suitable heights of the side walls 6 are from 6 inches to 3 feet, preferably from 6 inches to 2 feet.

The side walls 6 can be connected to each other by one or more spacers 30. The spacers 30 can also have the function of guiding the optical fiber cable and/or innerduct/microduct 121 into and through the laybox 3 and then to bottom of the microtrench 11. For example, the spacers 30 can be bolts that bolt the sides walls 6 together.

A crummer 4 can be located at the front of the laybox 3. The crummer 4 is configured to remove remaining spoil 12 or other objects from the microtrench 12. The crummer 4 can have a pointed or angled surface to facilitate removal of the spoil 12.

A microtrencher connector 19 can be located near the front of the laybox 3 for connecting the laybox 3 to the microtrencher 2. The microtrencher connector 19 can have holes 21 for bolting the microtrencher connector 19 to the microtrencher 2.

A fill conduit 126 can be located at the rear of the laybox 3, which is configured to direct fill 127 to flow through the fill conduit 126 and into the microtrench 11. The microtrench 11 containing the optical fiber cable and/or innerduct/microduct 121 can be filled with fill 127 from a fill device 200 connected to the fill conduit 126 by a fill hose 201. Preferably, the fill device 200 and the fill 127 are as disclosed in my U.S. publication No 20190086002 or U.S. publication No. 20180292027, which are incorporated herein by reference.

During use of the second embodiment, the microtrench 11 can be cut in the hard roadway (asphalt or cement) using the blade 10. The spoil 12 from the blade 10 is vacuumed away using the vacuum device 130. The laybox 3 connected to the microtrencher 2 is dragged forward inside the microtrench 11 as the microtrencher 2 moves forward. The crummer 4 pushes any spoil 12 or other debris in the microtrench 11 up and out of the way of the laybox 3. As the laybox 3 moves forward in the microtrench 11, the optical fiber cable and/or innerduct/microduct 121 is fed through the chamber 8, the path being controlled by the spacers 30, until the optical fiber cable and/or innerduct microduct 121 lays at the bottom of the microduct. Fill 127 is fed from the fill device 200 to the fil conduit 126 through a fill hose 131. The fill 127 flows through the fill conduit 126 to cover the optical fiber cable and/or innerduct/microduct 121 and fill the microtrench 11. During forming curves in the microtrench 11, the laybox 3 may have to be removed from the curved portion of the microtrench 11 and then reinstalled within the microtrench 11 as the microtrench 11 straightens out. A lifting device on the microtrencher 2 can be used to raise and lower the laybox 3, which can also be used in the first embodiment. Any suitable lifting device can be utilized, such as hydraulic, electric, spring, and or manual.

### REFERENCE NUMBERS

2 Microtrencher

3 Laybox

4 Crummer

6 Side wall

8 Elongated chamber defined by side walls 6

10 Cutting wheel

11 Microtrench

12 Spoil

14 Spoil 12 returned to the microtrench 11

19 Microtrencher connector

20 Microtrencher shroud

21 Holes

30 Spacer

40 Compression wheel mount

42 Mount support arm

44 Swing arm to allow wheel 50 to move up and down

50 Compression wheel for compressing spoil 12 in the microtrench 11

60 Spoil diverter

120 Weight

121 Optical fiber cable or innerduct/microduct

124 Vacuum truck

126 Fill conduit in laybox

127 Fill in microtrench 11

130 Vacuum device

131 Vacuum hose

150 Reel device containing reels of optical fiber cable and/or innerduct/microduct 121

200 Fill Device

201 Fill hose

210 Compactor

To facilitate an understanding of the principles and features of the various embodiments of the present invention, various illustrative embodiments are explained below. Although example embodiments of the present invention are explained in detail, it is to be understood that other embodiments are contemplated. Accordingly, it is not intended that the present invention is limited in its scope to the details of construction and arrangement of components set forth in the following description or examples. The present invention is capable of other embodiments and of being practiced or carried out in various ways.

As used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the example embodiments, terminology will be resorted to for the sake of clarity. It is intended that each term contemplates its broadest meaning as understood by those skilled in the art and includes all technical equivalents that operate in a similar manner to accomplish a similar purpose.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified. Such other components or steps not described herein can include, but are not limited to, for example, similar components or steps that are developed after development of the disclosed technology.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1. A laybox configured for installing optical fiber cable in a microtrench comprising:
a body comprising opposing first and second elongated sheets of steel defining an elongated chamber between them, the body having a thickness of 1 to 6 inches to fit within a microtrench, and a front end of the body configured to face a microtrencher cutting blade and a back end of the body opposing the first end; and
a cable guide disposed in the elongated chamber configured to guide an optical fiber cable and/or microduct/innerduct through the chamber.

2. The laybox according to claim 1, further comprising a microtrencher connector for connecting the laybox to a microtrencher disposed at the front end of the body;

3. The laybox according to claim 1, wherein the cable guide comprises a plurality of spacers disposed in the elongated chamber.

4. The laybox according to claim 3, wherein the plurality of spacers connect the first and second sheets together.

5. The laybox according to claim 1, further comprising a spoil diverter at the back end of the body configured to push spoil into a microtrench.

6. The laybox according to claim 1, further comprising a compression wheel at the back of the body configured to compress spoil in a microtrench.

7. The laybox according to claim 1, further comprising a compactor configured to compress spoil in a microtrench.

8. The laybox according to claim 1, further comprising a fill conduit at the back end configured to flow fill through the laybox and into a microtrench.

9. A method of microtrenching comprising:
cutting a microtrench in a roadway with a microtrencher and depositing spoil from the microtrench on one side of the microtrench;
moving a laybox in the microtrench behind the microtrencher in a direction the microtrencher is travelling, the laybox comprising opposing first and second elongated sheets of steel defining an elongated chamber between them and a cable guide in the elongated chamber;
flowing an optical fiber cable and/or innerduct/microduct through the chamber and cable guide so that the optical fiber cable and/or innerduct/microduct is laying in the microtrench;
pushing the spoil into the microtrench using a spoil diverter; and
compressing the spoil in the microtrench.

10. The method according to claim 9, wherein the opposing first and second elongated sheets of steel are connected by a plurality of spacers, and at least one of the plurality of spacers defining the cable guide.

11. The method according to claim 9, further comprising using a wheel to compress the spoil in the microtrench.

12. The method according to claim 11, further comprising using a weight connected to the compression wheel to provide additional compression force during compressing the spoil.

13. The method according to claim 9, further comprising using a compactor to compress the spoil in the microtrench.

14. A method of microtrenching comprising:
cutting a microtrench in a roadway comprising asphalt or cement with a microtrencher;
vacuuming spoil from the microtrench using a vacuum device;
moving a laybox in the microtrench behind the microtrencher in a direction the microtrencher is travelling, the laybox comprising opposing first and second elongated sheets of steel defining an elongated chamber between them and a cable guide in the elongated chamber;
flowing an optical fiber cable and/or innerduct/microduct through the chamber and cable guide so that the optical fiber cable and/or innerduct/microduct is laying in the microtrench; and
flowing a fill from a fill device to a fill conduit in the laybox so that the fill flows through the fill conduit and into the microtrench to seal the microtrench and protect the optical fiber cable and/or innerduct/microduct.
